(19) United States
(12) Patent Application Publication
(10) Pub. No.: US 2006/0279558 A1
(43) Pub. Date: Dec. 14, 2006

(54) Touc input screen using a light guide

(75) Inventors: Martinus Hermanus Wilhelmus Mari Van Delden, Eindhoven (DE); Hugo Johan Cornelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninklike phillips electronics n.v.

(21) Appl. No.: 10/572,622

(22) PCT Filed: Sep. 8, 2004
(86) PCT No.: PCT/IB04/51713

§ 371 Date: Mar. 17, 2006

(30) Foreign Application Priority Data
Sep. 22, 2003 (EP) 03103490.3

(51) Int. Cl. G09G 5/00

(52) U.S. Cl. 345/176

(57) ABSTRACT

The present invention relates to a display device having a touch screen (301). The touch screen comprises a first light guide (302), a second light guide (307) and a media (309) between the light guides for eliminating interference and reflections. A light source (308) is arranged to emit light (310) into the first light guide (302), which light is normally confined within the first light guide by means of total internal reflections. The second light guide (307) is arranged at the exterior face of the first light guide (302). When a user of the display device establishes physical contact with the touch screen (301), light is extracted from the first light guide and directed towards light detecting means (303). The light detecting means (303) are arranged for relating a light detecting event to an input position on the touch screen (301), where user interaction occurred.

The present invention relates to a display device having a display with touch screen functionality.

In various display technologies, touch input screens are well known. These screens commonly employ a pair (for one-dimensional coordinate detection) of parallelly aligned, transparent membranes made of, for example, PET foil, polymethyl methacrylate (PMMA) or polycarbonate. Each membrane accommodates a thin transparent and conductive Indium Tin Oxide (ITO) film. The two membranes are usually separated from each other by an air gap of about 500-1000 μm. The ITO films attached to the membranes are facing each other, i.e. the membranes are aligned such that the ITO films are arranged in between the two membranes.

In general, a resistor-based touch screen is applied as an add-on module to a given display panel. Along each of two opposite edges of one of the two high resistance ITO films, an electrode having a very low resistance is applied. When a voltage is applied across the low resistance electrodes, equipotential lines arise (parallel to the electrodes) across the ITO film. The potential of the lines ranges from, say, 0V at one end of the ITO film to 10V at the other end. When the membrane which faces the display panel surroundings is touched by means of a finger, a pen or some other appropriate pointer object, this membrane, as well as the associated ITO resistors, is deformed until said membrane touches the membrane which faces the display panel, wherein the two ITO films are brought into contact with each other. As a result, the potential of the equipotential line at the touch position is transferred to the membrane facing the display panel. From an electrical point of view, this membrane is floating, and when the potential of such a floating body is measured at zero-current flow, the touch position may be calculated from the measured voltage.

For two-dimensional coordinate detection, an additional pair of parallelly aligned, transparent electrodes is attached to the other membrane, the additional pair having its electrodes arranged such that the equipotential lines of the additional pair are perpendicular to the equipotential lines of the existing electrode pair. Thus, the X- and Y-coordinates can be measured.

This type of touch screens has a number of disadvantages, of which cost is a major one. For example, a PDA-size touch screen costs somewhere in the range $10-$20, while a 15″ touch screen costs $200 or more. An important factor for the end user is the resulting Front-of-Screen (FoS) performance which includes parameters such as luminance, brightness, contrast, response time etc. The FoS performance of an LCD equipped with a touch screen is significantly poorer than the FoS performance of an identical LCD without a touch screen. The deteriorated FoS performance of the touch screen LCD is, for instance, due
light scattering by the resistors in the membrane results in blurred vision and reduced contrast;
discoloration of the screen as a result of the resistors in the membrane;
absorption of light in the membrane and the ITO film, reducing the experienced brightness;
an interface of air between the membrane surface facing the display and the display itself, resulting in undesired refections, interference pattern and a reduced viewing angle.

Anti reflection coatings can be used to reduce reflections. However, they need to be applied at the membrane-air interface, while the ITO films must be deposited on the other side of the membrane, resulting in expensive double-sided deposition, processing and handling procedures. Moreover, antireflection coatings do not suppress light scattering and discoloration by the ITO film and they may increase the transmission loss. Refractive index matching fluids can be used as media instead of air in between the membranes in order to reduce reflections. This will, however, result in deteriorated ohmic contact between the ITO films.

UK Patent Application GB 2 074 428 discloses a touch sensitive device having a laminar light guide, inside which light from a source, such as the screen of a CRT, can be trapped by total internal reflection by applying a pressure to the light guide by means of a finger. The edges of the light guide are fitted with photo detectors which respond to the entrapment of light in the light guide.

It is possible to determine the exact touch position on the light guide by comparing the photo detector output with the CRT raster position.

A problem with GB 2 074 428 is that the air interface of the light guide causes optical interference and reflections. Another problem is that any light guide surface contamination, such as fingerprints, dust, scratches etc, might result in the fact that light is trapped in the light guide and the photo detectors might respond to this trapped light Thus, the contamination may be detected, which results in a so called “ghost touch”, i.e. an accidental touch input.

An object of the present invention is to provide a touch screen display device which has excellent Front-of-Screen performance and avoids ghost touch inputs.

This object is achieved by a display device according to claim 1. Preferred embodiments are defined by the dependent claims.

According to an aspect of the invention, a display device includes a display with touch screen functionality, i.e. the display device is arranged for detecting an input position on the screen of the display. For this purpose, the screen comprises a first light guide arranged with a light source which emits light into the first light guide. The first light guide is optically matchaed with its surroundings in such way that the light of the light source is normally confined within the first light guide by means of total internal reflection. ‘Nonnally’ in this context should be understood to refer to the situation that no user interaction with the screen occurs.

When a user physically interacts with the touch screen at the input position, by means of a finger, a pen or some other pointer object, the state of total internal reflection of the light in the first light guide is disturbed, so that light is extracted from the first light guide.

The screen further comprises a second light guide arranged so that the interaction of the user with the touch screen establishes a contact between the first and second light guides. Moreover, the screen comprises a media separating the first and second light guides. The media has a lower refractive index than that of the respective first and second light guide.

Detection of the input position is done in one of two ways. Light detecting means in the form of e.g. photo detectors or photo sensors are provided, which either detect the light extracted from the first light guide, or a decrease in light intensity in the first light guide. The light detecting means are also arranged to relate a light detecting event to the input position on the touch screen, where the user interaction took place.

The present invention is advantageous, since reliable detection of touch inputs can be provided in most types of displays, such as LCD, CRT, different type of LED technologies, e.g. OLED, PLED etc. Devices in which the present invention can be applied include mobile phone screens, different types of monitoring devices, television sets, projection screens etc.

Detection of a touch input is possible when the user of the display device establishes physical contact with the second light guide arranged in front of the screen, which results in the fact that ghost touch inputs will be avoided. Fingerprints, dirt, dust or other unwanted substances on the touch screen, i.e. the second light guide, will not cause undesired out-coupling of light from the first light guide.

Moreover, by virtue of the media separating the first and the second light guide, the effect of undesired reflections and interference patterns is mitigated. This is due to the fact that the light guide-media interfaces will have a lower Fresnel reflection coefficient in comparison with light guide-air interfaces employed in the prior art.

In the prior art, when light rays are incident on a display especially under shallow angles, the reflections on a surface-air interface increases gradually, reaching almost 100% for an incident angle close to 90°. If multiple surface-air interfaces are encountered, total reflection would even occur at relatively small angles of incidence. Moreover, if the surface-air interfaces are separated from each other by relatively large distances (larger than ˜200 μm), shadows will occur on the display.

By virtue of the media between the two light guides, the negative effects of surface reflections are reduced and a display is obtained with a strongly increased viewing angle.

According to a preferred embodiment of the invention, when the light guides are in (optical) contact with each other by virue of user interaction, the light that is extracted from the first light guide enters into the second light guide. Preferably, the light detecting means are than arranged adjacent said second light guide, in essentially the same plane therewith. For example, photo detectors are located along the edges of the second light guide.

Preferably the second light guide is made of a flexible material. In this case, a user interaction with the touch screen causes the second light guide to be deflected into contact with the first light guide.

Preferably the surface of the second light guide facing the first light guide is structured such that the surface has a certain roughness. This is advantageous, since the roughness of the surface prevents the second light guide from adhering to the first light guide.

According to another embodiment of the invention, the media is a liquid having a refractive index in the range of 1.30-1.48, the liquid being enclosed in an expandable container arranged between the first and the second light guide. This embodiment is advantageous as the liquid enclosed in the expandable container easily can be displaced in the container when a user deflects the second light guide.

Preferred liquids include fluorine-based silicon fluids or alcohol/water mixtures. This is advantageous, since these types of liquids are rather temperature insensitive. Further, these types of liquids are transparent and colorless, chemically inert, non-scattering and have a low refractive index.

According to a further embodiment of the invention, the first and second light guide consist of a material having a refractive index in the range of 1.49-1.58, preferably PMMA. Such a light guide can easily be manufactured by employing injection molding processes.

According to yet another embodiment of the invention, the light source arranged to emit light into the first light guide emits non-visible light. This has the advantage that the light of the light source does not cause deterioration of the viewing properties of the display, since the light is not visible to the human eye.

Further features of, and advantages with, the present invention will become apparent when studying the appended claims and the following description. Those skilled in the art realize that different features of the present invention can be combined to create embodiments other than those described in the following.

The present invention will be described in detail with reference made to the accompanying drawings. Like reference number denotes corresponding elements throughout the drawings, in which:

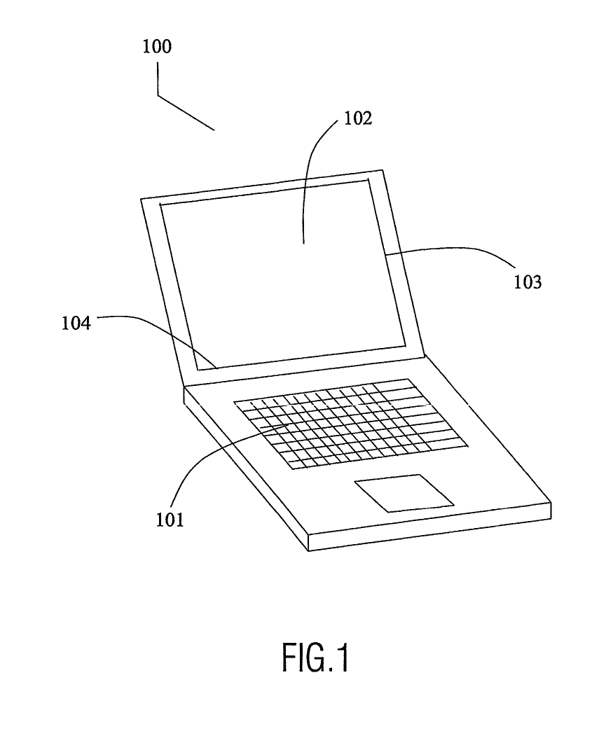

FIG. 1 shows an example of a prior art display device in which the present invention can be applied;

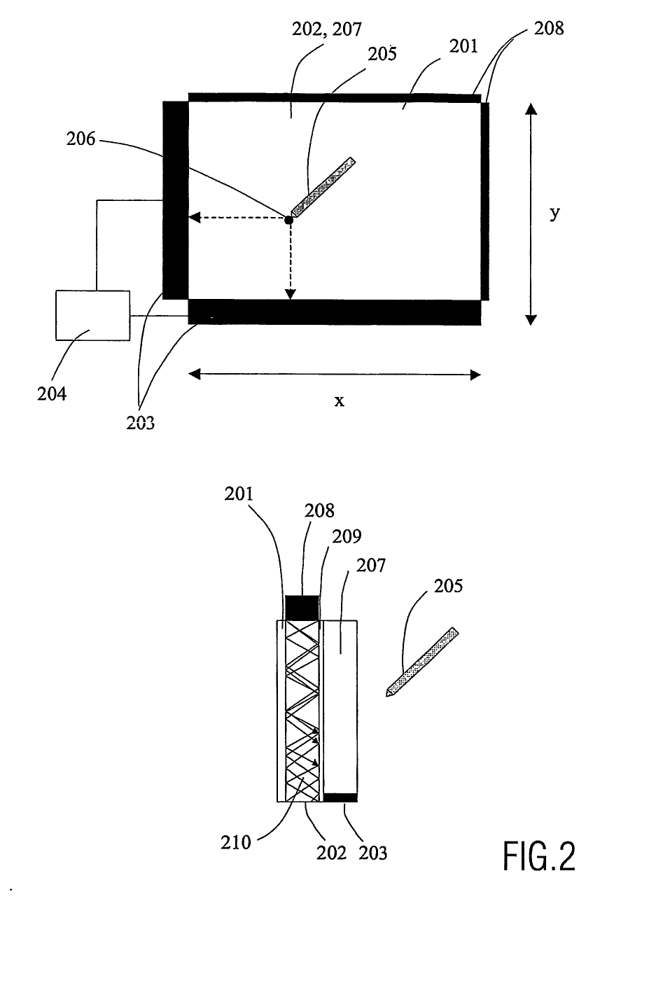

FIG. 2 shows a schematic front view and a side view of the display of a display device, on which display two light guides are arranged in accordance with an embodiment of the present invention;

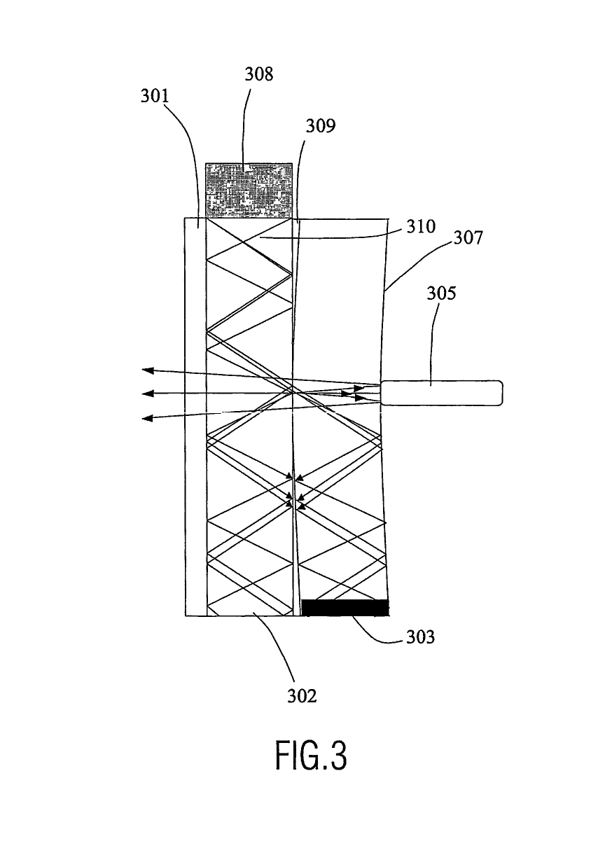

FIG. 3 shows a side view of a light guide for which the total internal reflection is perturbed;

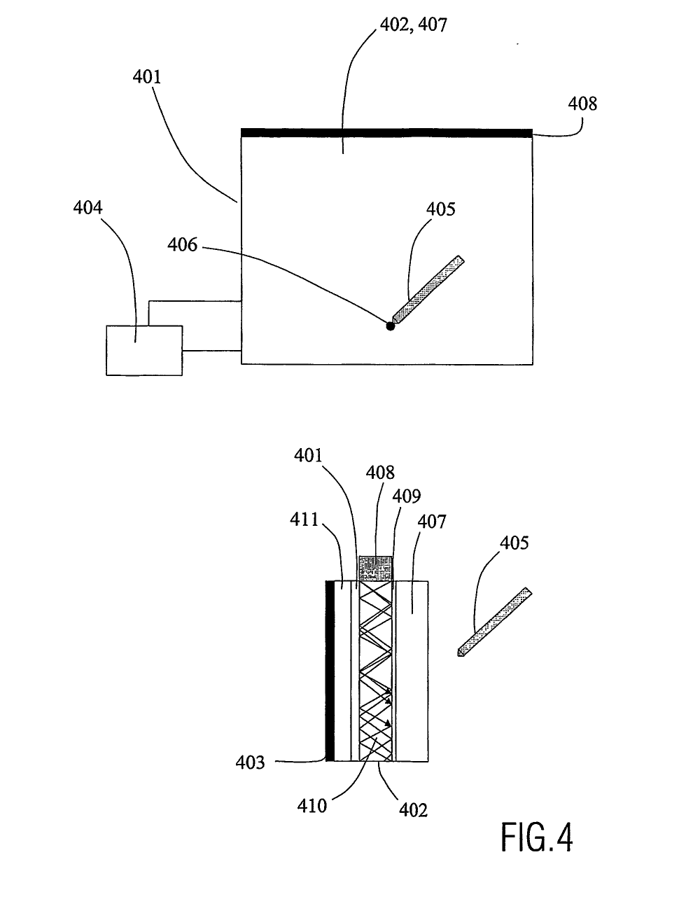

FIG. 4 shows a schematic front view and a side view of the display of a display device, on which display two light guides are arranged in accordance with another embodiment of the present invention;

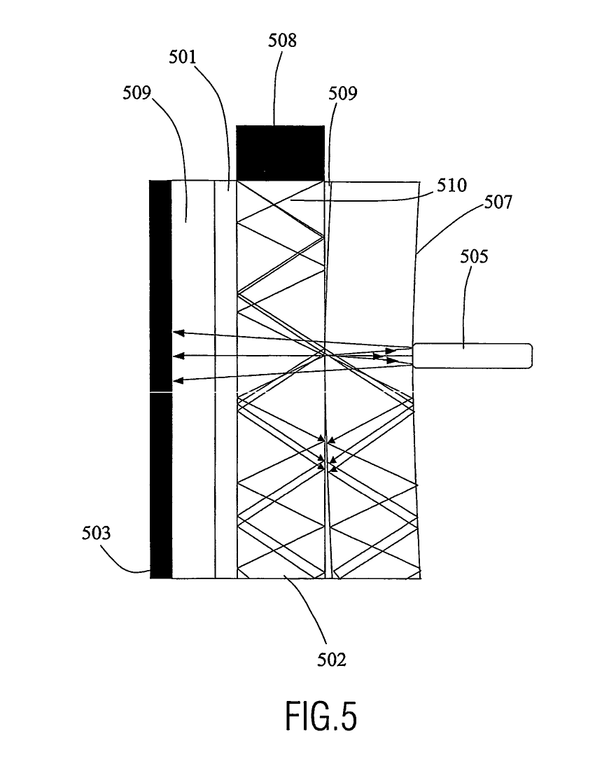

FIG. 5 shows a side view of the light guide of FIG. 4, for which light guide the total internal reflection is perturbed;

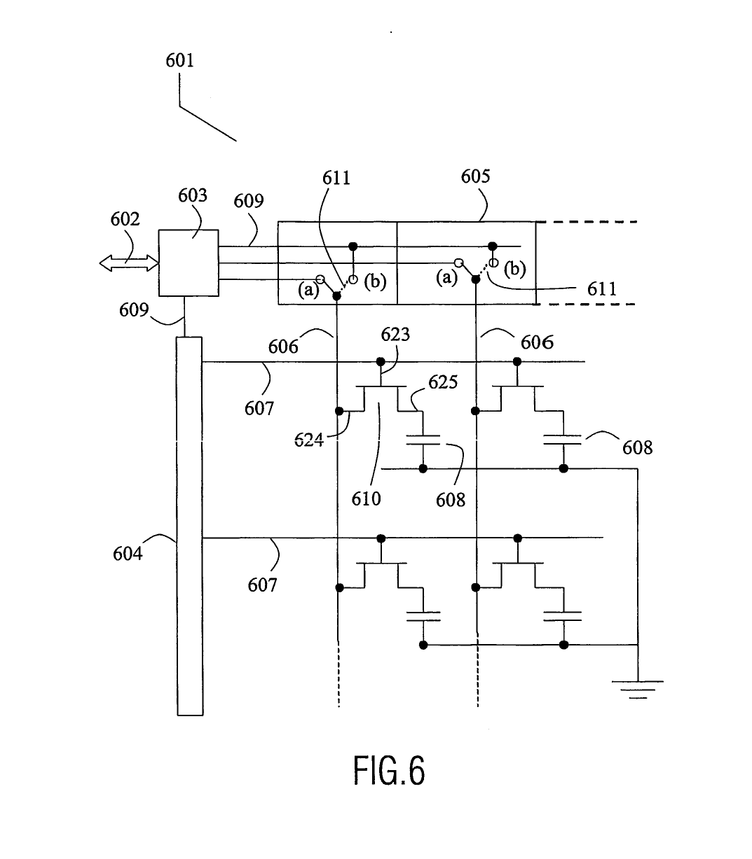

FIG. 6 shows a schematic view of a part of a display device to which the present invention is applicable; and

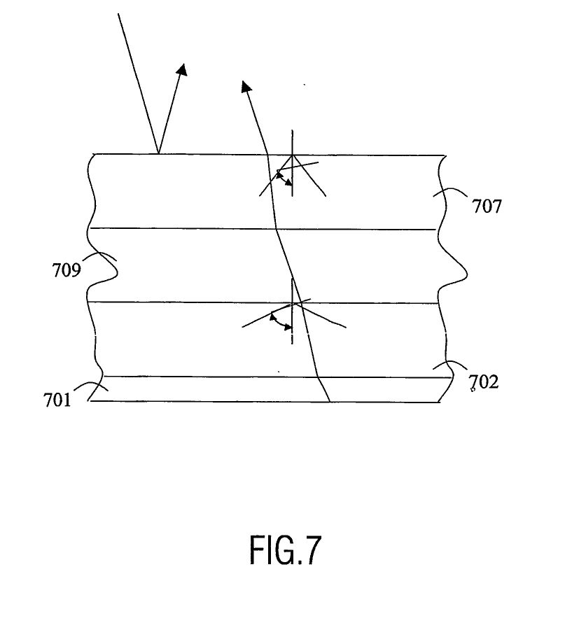

FIG. 7 illustrates reduction of reflections and interference patterns.

FIG. 1 shows a display device 100 in the form of a laptop arranged with a keyboard 101 and an LCD flat display 102, in which display device the present invention advantageously can be applied. The display device having touch screen functionality according to the present invention, comprising two light guides, a media separating the two light guides and light detecting means, can be arranged in the display device in a number of different ways, as will be described. For example, the light guides can be arranged at the exterior of the display, as an add-on module. The light detecting means can be arranged at two of the edges 103, 104 of the display in the case the display device consist of e.g. a television set, a projection screen or a CRT. The light detecting means can also be arranged in a substrate of the display device, in case the display device comprise an active matrix substrate, thereby placing the light detecting means in the interior of the display device.

The upper portion of FIG. 2 shows a schematic front view of the display 201 of a display device, on which display two light guides, an inner light guide 202 and an outer light guide 207, are arranged by means of e.g. adhesive. The lower portion of FIG. 2 shows a schematic side view of the display 201. At two of the edges of the outer light guide 207, light detecting means 203 in the form of e.g. photo detectors are arranged. This light detector arrangement is preferably used when the display device does not contain an active matrix substrate, for example when the display device includes a television set, a CRT or a projection screen. The light detecting means are connected to a CPU 204 or some other appropriate means having processing capabilities. Advantageously, the CPU can comprise the existing processing means in the device to which the touch screen functionality is applied. However, the two light guides and the light detecting means can be a stand-alone system with its own CPU, which stand-alone system is connected to, and made cooperative with, the device for which touch screen functionality is to be provided. A pointing device in the form of a pen 205 can be employed by a user to establish contact 206 with the display. The inner light guide 202 has a light source 208 arranged to emit light into the inner light guide.

The optical matching between the inner light guide 202 and the liquid 209, the liquid being enclosed in an expandable container, is adapted such that the light 210 of the light source 208 is confined within the inner light guide by means of total internal reflection. The liquid 209 comprises fluorine-based silicon fluids or alcohol/water mixtures having a refractive index in the range of 1.30-1.48. The light guides 202,207 is made up of PMMA or glass-type materials having a refractive index of 1.50. In practice, any liquid being transparent, colorless, chemically inert and non-scattering will do as long as its refractive index is smaller than the index of the light guide material, yet still close enough to provide a good optical match.

FIG. 3 shows a side view of the display 301 of the display device. Physical contact with the outer light guide 307 by means of, for example, a pen 305 deflects the outer light guide into contact with the inner light guide 302. This perturbs the total internal reflection in the inner light guide, and at the contact interface of the inner light guide and the outer light guide, light 310 from the light source 308 is extracted and directed towards the light detecting means 303. Thus, it is possible to determine the point of contact on the display by determining the point(s) of incidence of light 310 impinging on the light detecting means 303 from the light source via the light guides. At the point of contact, light is scattered in multiple directions. FIG. 3 shows a simplified view of this scattering which generally occurs in a great number of directions. Also note that in FIG. 3, the detection of the X-coordinate is shown. The detection of the Y-coordinate is performed by the light detecting means which is arranged perpendicular to the detectors that detect the X-coordinate (see FIG. 2).

By using the arrangement shown in FIG. 3, detection of a touch input is possible only when the user of the display device establishes contact with the outer light guide arranged in front of the display, which results in the fact that ghost touch inputs will be avoided. Fingerprints, dirt, dust or other unwanted substances on the display exterior, i.e. the outer light guide, will not cause accidental out-coupling of light from the inner light guide. Moreover, the liquid 309 separating the inner and outer light guide will mitigate the effect of undesired reflections and interference patterns. This will be described in detail later. The surface of the outer light guide which faces and is deflected into contact with the first light guide can optionally be structured to prevent adhesion to the inner light guide.

FIG. 4 shows another arrangement for detection of light, wherein the light detecting means are integrated in the substrate of the display device. This light detection arrangement is preferred when the display device has an active matrix substrate. This is the case for, for example, LCD and different type of LED technologies, e.g. OLED, PLED etc.

The lower portion of FIG. 4 shows a schematic side view of the display device screen 401. The light detecting means 403 in the form of thin film transistors (TFTs) are integrated in the active matrix substrate 409 of the display device to detect incident light. The inner light guide 402 has a light source 408 arranged to emit light into the inner light guide. Note that in this case, it is only necessary to emit light from one side of the inner light guide, as compared to the arrangement shown in FIG. 2. The light detecting means 403 does not necessarily comprise TFTs. It is possible that the substrate 409 is composed of a photo sensitive material arranged to detect the light which is extracted from the light guide 202 and directed towards the light detecting means 403.

Turning to FIG. 5, physical contact with the outer light guide 507 by means of, for example, a pen 505 deflects the outer light guide into contact with the inner light guide 502. This perturbs the total internal reflection in the inner light guide, and at the contact interface of the inner light guide and the outer light guide, light 510 from the first light source 508 is extracted and now directed predominantly towards the light detecting means 503 in the substrate. Thus, it is possible to determine the point of contact on the display by determining the point(s) of incidence of light 510 impinging on the light detecting means 503 from the light source via the light guides. At the point of contact, light is scattered in multiple directions. In other words, it can be said that the point of contact on the outer light guide 507 acts as a light source which emits the light onto the TFTs 503.

FIG. 6 shows a schematic view of a part of a display device 601 to which the present invention is applicable. It comprises a matrix of elements or pixels 608 at the areas of crossings of row or selection electrodes 607 and column or data electrodes 606. The row electrodes are selected by means of a row driver 604, while the column electrodes are provided with data via a data register 605. To this end, incoming data 602 are first processed, if necessary, in a processor 603. Mutual synchronization between the row driver 604 and the data register 605 occurs via drivelines 609.

Signals from the row driver 604 select the picture electrodes via thin film transistors (TFTs) 610 whose gate electrodes 623 are electrically connected to the row electrodes 607 and the source electrodes 624 are electrically connected to the column electrodes. The signal which is present at the column electrode 606 is transferred via the TFT to a picture electrode of a pixel 608 coupled to the drain electrode 625. The other picture electrodes are connected to, for example, one (or more) common counter electrode(s). The data register 605 also contains switches 611 by which either incoming data can be transferred to the column electrodes 606 (situation 611a), or during a sensing stage, the status of TFTs 610 can be sensed (situation 611b of the switches 611).

A characteristic of semi-conducting materials is photo electricity, which means that a photo-induced leakage current is induced in a TFT 610, when the TFT is exposed to light. Therefore, the TFTs in conventional displays are shielded from any incident light by a light-rejecting layer (not shown), such as a black-matrix layer. By making an opening in the light-rejecting layer or by replacing the light-rejecting layer with a layer of another material which is opaque to a specified wavelength, the TFTs can be made sensitive to external light (of a specified wavelength).

A light beam may illuminate a TFT 610 locally, and the voltage stored on the capacitor 608 related to the TFT drops on illumination. Sensing of this voltage drop (situation 611b of the switches 611) before writing new information during a next write cycle enables distinguishing between an intentionally illuminated pixel and a non-illuminated pixel. The sensed information is stored in processor 603 and by using dedicated software, the point of incidence of light impinging on the display from the display device exterior can be detected.

FIG. 7 illustrates the reasons why the liquid which is arranged between the light guides reduce reflections and interference patterns. FIG. 7 comprises the outer light guide 707 and the inner light guide 702. These light guides are composed of PMMA and have a refractive index (n₂) of 1.5. A liquid 709 having a refractive index (n₁) of 1.4 is arranged in between the light guides. The inner light guide is, as in the previous embodiments, attached to a display 701 of a display device. The media on the exterior side of the outer light guide is air, thus having a refractive index of 1.0. The Fresnel reflection defined in (1) describes the reflection of a portion of incident light at the interface between two media having different refractive indices.

$$R = {( \frac{{n}_{1} - {n}_{2}}{{n}_{1} + {n}_{2}} )}^{2} \qquad ( 1 )$$

The Fresnel reflection at the air-PMMA interface of the outer light guide 707 is thus 4%. In case air would be used instead of liquid 709, a light ray would travel further towards a second, a third and a fourth air interface, and additional reflections would be created at each of the air interfaces. For the PMMA-liquid interfaces, the Fresnel reflection equals 0.12%, which is a significant reduction of the reflections. Note that these Fresnel values are given for light having an incident angle of 0°. Obviously, the use of the liquid will increase the visibility of the display device, being for example an LCD, emitting a certain amount of light.

The importance of reducing the number of air interfaces becomes even more significant when light rays are incident under shallow angles. In that case, the reflections in the air interface at first increases gradually, before rapidly rising to about 100% for an incident angle close to 90°. If a number of air interfaces are encountered, total reflection will occur for even smaller angles of incidence. Moreover, if multiple air interfaces are encountered, the interfaces being separated by relatively large distances (larger than ˜200 μm), shadows will occur on the display. In other words, the viewing angle of the display is reduced more rapidly using a number of PMMA-air interfaces when compared to a single PMMA-air interface as is the case in the present invention.

When considering the conditions associated with total internal reflection of light in the inner light guide 702 and the difficulties associated with light coupling into a light guide, it is preferred to use a liquid/fluid 709 having a refractive index of ˜1.4 rather than 1.48. This is simply because the range of angles of incidence for which total internal reflection occurs within the light guide is increased. Turning to FIG. 7, for the inner light guide 702, light rays having an incident angle larger than arcsin(1.4/1.5)≈69° will be trapped in the light guide. On the other hand, if the liquid 709 would have a refractive index of 1.48, light rays having an incident angle larger than arcsin(1.48/1.5)≈81° would be trapped in the light guide. Clearly, 90°−81°=9° is a narrow range for angles of incidence for which total reflection occurs, and angles smaller than 81° will leak out of the inner light guide, causing clearly visible bright spots on the display and possibly ghost touch inputs. When taking the dimensions of available light sources (LED, IR-lamps etc), practical dimensions of light guides, collimation and light coupling issues into account, the liquid is preferably chosen such that the following condition is satisfied:
n₂−n₁≧0.1

The refractive index of the liquid is, however, not limited to this value.

Even though the invention has been described with reference to specific exemplifying embodiments thereof many different alterations, modifications and the like will become apparent for those skilled in the art. The described embodiments are therefore not intended to limit the scope of the invention, as defined by the appended claims.

1. A display device, including a display, arranged for detecting an input position on a screen (301) of said display,
wherein the screen (301) comprises:
a first light guide (302), and a light source (308) arranged to emit light (310) into the first light guide (302), the first light guide (302) being optically matched with its surroundings in such way that the light (310) emitted from said light source (308) is confined within the first light guide (302) by means of total internal reflection, and is extracted from the first light guide (302) when a user physically interacts with said screen (301) at said input position;
a second light guide (307) arranged so that said user interaction with said screen (301) establishes a contact between said first light guide (302) and said second light guide (307), and
a media (309) between the first and second light guides, the media having a lower refractive index than the respective refractive index of the first and the second light guides,

2. A display device as claimed in claim 1, wherein at least part of the light extracted from the first light guide (302) enters into the second light guide (307) when contact is established between the first and second light guides, said extracted light being confined in the second light guide (307) by means of total internal reflection.

3. A display device as claimed in claim 1, wherein the display device further comprises detecting means (303) for detecting the light extracted from the first light guide (302) and relating the detecting of the light to said input position.

4. A display device as claimed in claim 2 wherein the light detecting means (303) are arranged adjacent said second light guide (307) in essentially the same plane therewith.

5. A display device as claimed in claim 1, wherein the user physically interacts with the second light guide (307) being made of a flexible material.

6. A display device as claimed in claim 1, wherein the display device further comprises detecting means for detecting a decrease in light intensity in the first light guide and relating the decrease in light intensity to said input position.

7. A display device as claimed in claim 1, wherein a surface of the second light guide (507) facing the first light guide (502) is structured so as to prevent adhesion to the first light guide when the contact between the first and second light guides is established.

8. A display device as claimed in claim 1, wherein the media (509) is a liquid having a refractive index in the range of 1.30-1.48, the liquid being enclosed in an expandable container arranged between the first (502) and the second light guide (507).

9. A display device as claimed in claim 8, wherein the liquid (509) comprises fluorine-based silicon fluids or alcohol/water mixtures.

10. A display device as claimed in claim 1, wherein the first (502) and second light guide (507) consist of a material having a refractive index in the range of 1.49-1.58.

11. A display device as claimed in claim 10, wherein the material includes polymethyl methacrylate.

12. A display device as claimed in claim 1, wherein the light source (508) arranged to emit light (510) into the first light guide (502) emits light having a wavelength outside the visible spectrum.

13. A display device as claimed in claim 12, wherein the light (510) of the light source (508) is infrared or near-ultraviolet light.
